(19) United States
(12) Patent Application Publication
(10) Pub. No.: US 2015/0062064 A1
(43) Pub. Date: Mar. 5, 2015

(54) TOUCH SENSITIVE DEVICE

(71) Applicant: TIANJIN FUNAYUANCHUANG TECHNOLOGY CO.,LTD., Tianjin (CN)

(72) Inventors: PO-SHENG SHIH, New Taipei (TW); CHIEN-YUNG CHENG, New Taipei (TW); CHIH-HAN CHAO, New Taipei (TW); JIA-SHYONG CHENG, New Taipei (TW)

(73) Assignee: TIANJIN FUNAYUANCHUANG TECHNOLOGY CO.,LTD., Tianjin (CN)

(21) Appl. No.: 14/158,697

(22) Filed: Jan. 17, 2014

(30) Foreign Application Priority Data
Aug. 30, 2013 (CN) 2013103869527
Sep. 27, 2013 (CN) 2013104472223
Nov. 29, 2013 (CN) 2013106211961

(51) Int. Cl. G06F 3/046

(52) U.S. Cl. CPC G06F 3/046
USPC 345/174

(57) ABSTRACT

The disclosure relates to a touch sensitive device. The touch sensitive device includes a touch module, a display module. The touch module and the display module are stacked together. The touch module includes a first transparent conductive layer and the display module includes a second transparent conductive layer. A distance between the first transparent conductive layer and the second transparent conductive layer is changeable under a pressure. The first transparent conductive layer and the second transparent conductive layer function as a touch pressure sensing unit together.

This application claims all benefits accruing under 35 U.S.C. §119 from China Patent Applications: Application No. 201310386952.7, filed on Aug. 30, 2013, Application No. 201310447222.3, filed on Sep. 27, 2013, and Application No. 201310621196.1, filed on Nov. 29, 2013, in the China Intellectual Property Office, disclosures of which are incorporated herein by references.

### BACKGROUND

1. Technical Field

The present disclosure relates touch sensitive devices, particularly to a three-dimensional touch sensitive device.

2. Description of Related Art

In recent years, various electronic apparatuses such as mobile phones, car navigation systems have advanced toward high performance and diversification. There is continuous growth in the number of electronic apparatuses equipped with optically transparent touch panels in front of their display devices such as liquid crystal panels.

A user of such electronic apparatus operates it by pressing a touch panel with a finger or a stylus while visually observing the display device through the touch panel. Thus a demand exists for such touch panels which superior in visibility and reliable in operation. Different types of touch panels, including a resistance-type, a capacitance-type, an infrared-type and a surface sound wave-type have been developed. A conventional capacitance-type touch panel usually includes an insulative substrate such as a glass plate, a transparent conductive layer such as an indium tin oxide (ITO) layer, and a plurality of electrodes. However, the touch panel is a two-dimensional touch sensitive device, and cannot detect the pressure of the finger of user.

What is needed, therefore, is to provide a touch sensitive device which can overcome the short come described above.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic view of one embodiment of a touch sensitive device.

FIG. 2 is a schematic view of one embodiment of a touch sensitive device.

FIG. 3 is a schematic view of one embodiment of a touch sensitive device.

FIG. 4 is a schematic view of one embodiment of a touch sensitive device.

FIG. 5 is a schematic view of one embodiment of a touch sensitive device.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

References will now be made to the drawings to describe, in detail, various embodiments of the touch sensitive devices.

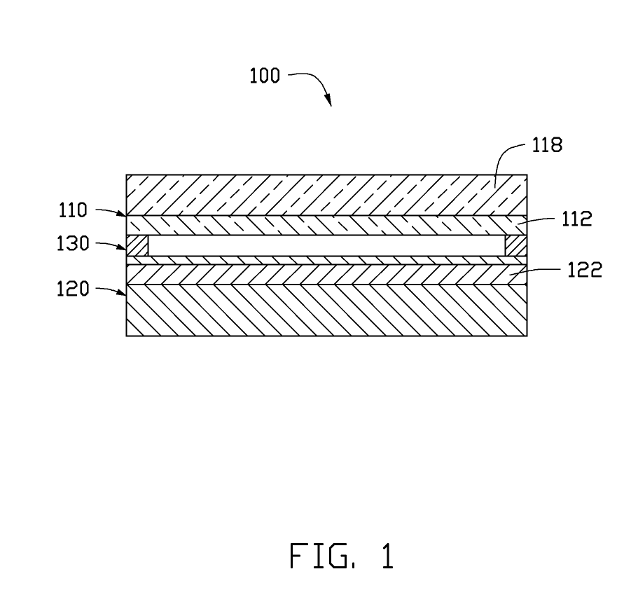

Referring to FIG. 1, a touch sensitive device 100 of one embodiment includes a touch module 110, and a display module 120. The touch module 110 and the display module 120 are stacked with and spaced from each other. The distance between the touch module 110 and the display module 120 can be selected according to need. In one embodiment, the touch module 110 and the display module 120 are overlapped with each other. The touch module 110 covers the display module 120.

The touch module 110 is a self inductance capacitance-type touch module. The touch module 110 includes a first transparent conductive layer 112, a plurality of electrodes (not shown) located on at least one side of and electrically connected with the first transparent conductive layer 112, a protection layer 118 covering the first transparent conductive layer 112. In one embodiment, the touch module 110 is a super-thin touch panel consisting of the first transparent conductive layer 112, the protection layer 118, and the plurality of electrodes. The first transparent conductive layer 112 is located on and in direct contact with a surface of the protection layer 118 facing the display module 120.

The first transparent conductive layer 112 is a carbon nanotube layer. The carbon nanotube layer includes a single carbon nanotube film or a plurality of stacked carbon nanotube films. In one embodiment, first transparent conductive layer 112 is a carbon nanotube film with resistance anisotropy. Thus, the first transparent conductive layer 112 has good mechanical strength and flexibility and can have greater deformation without being destroyed.

The carbon nanotube film is a substantially pure structure consisting of a plurality of carbon nanotubes, with few impurities and chemical functional groups. The carbon nanotube film is a free-standing structure. The term “free-standing structure” includes, but is not limited to, the property that the carbon nanotube film can sustain the weight of itself when it is hoisted by a portion thereof without any significant damage to its structural integrity. Thus, the carbon nanotube film can be suspended by two spaced supports. The majority of carbon nanotubes of the carbon nanotube film are joined end-to-end by van der Waals force therebetween so that the carbon nanotube film is a free-standing structure. The carbon nanotubes of the carbon nanotube film can be single-walled, double-walled, or multi-walled carbon nanotubes. The diameter of the single-walled carbon nanotubes can be in about 0.5 nm to about 50 nm. The diameter of the double-walled carbon nanotubes can be in about 1.0 nm to about 50 nm. The diameter of the multi-walled carbon nanotubes can be in about 1.5 nm to about 50 nm.

The carbon nanotubes of the carbon nanotube film are oriented along a preferred orientation. That is, the majority of carbon nanotubes of the carbon nanotube film are arranged to substantially extend along the same direction and in parallel with the surface of the carbon nanotube film. Each adjacent two of the majority of carbon nanotubes of the carbon nanotube film are joined end-to-end by van der Waals force therebetween along the extending direction. A minority of dispersed carbon nanotubes of the carbon nanotube film may be located and arranged randomly. However, the minority of dispersed carbon nanotubes have little effect on the properties of the carbon nanotube film and the arrangement of the majority of carbon nanotubes of the carbon nanotube film. The majority of carbon nanotubes of the carbon nanotube film are not absolutely form a direct line and extend along the axial direction, some of them may be curved and in contact with each other in microcosm. Some variations can occur in the carbon nanotube film. Because the electric conductivity of the carbon nanotubes along the axial direction is much better than the electric conductivity along the radial direction, and the majority of the carbon nanotubes of the carbon nanotube film are substantially arranged to extend along the same direction, the carbon nanotube film is conductivity anisotropy.

The carbon nanotube film can be made by the steps of: growing a carbon nanotube array on a wafer by chemical vapor deposition (CVD) method; and drawing the carbon nanotubes of the carbon nanotube array to from the carbon nanotube film. During the drawing step, the carbon nanotubes are joined end-to-end by van der Waals attractive force therebetween along the drawing direction. The width of the carbon nanotube film can be in a range from about 1 millimeter to 10 centimeters, and the thickness of the carbon nanotube film can be in a range from about 0.5 nanometers to 150 micrometers. The carbon nanotube film has the smallest resistance along the drawing direction and the greatest resistance along a direction perpendicular to the drawing direction. Thus, the carbon nanotube film is resistance anisotropy. Furthermore, the carbon nanotube film can be etched or irradiated by laser. After being irradiated by laser, a plurality of parallel carbon nanotube conductive strings will be formed and the resistance anisotropy of the carbon nanotube film will not be damaged because the carbon nanotube substantially extending not along the drawing direction are removed by burning. Each carbon nanotube conductive string comprises a plurality of carbon nanotubes joined end-to-end by van der Waals attractive force.

In one embodiment, the carbon nanotube film includes a plurality of successively oriented carbon nanotube segments joined end-to-end by van der Waals attractive force therebetween. Each carbon nanotube segment includes a plurality of carbon nanotubes parallel to each other, and combined by van der Waals attractive force therebetween. The carbon nanotubes in the carbon nanotube film are oriented along a preferred orientation.

The free-standing carbon nanotube film can be drawn from a carbon nanotube array and then placed on the protection layer 118 directly. Because of the adhesive properties of the drawn carbon nanotube film, the carbon nanotube film can be attached on the protection layer 118 firmly. The carbon nanotube film can also be fixed on the protection layer 118 by an adhesive layer such as an optically clear adhesive (OCA) layer. The optically clear adhesive layer is located between the protection layer 118 and the carbon nanotube film.

The plurality of electrodes are located at one side of the first transparent conductive layer 112 and spaced from each other. The plurality of electrodes are arranged along a direction perpendicular with the extending direction of the carbon nanotubes of the first transparent conductive layer 112. The plurality of electrodes can be made of material such as metal, carbon nanotube, conductive silver paste, or transparent conductive oxide (TCO), and can be made by etching a metal film, etching an TCO film, or printing a conductive silver paste. The metal can be silver, tin, copper, or platinum. The material of the TCO film can be ITO, indium zinc oxide (IZO), aluminum zinc oxide (AZO), zinc oxide (ZnO) or tin oxide (TO). In one embodiment, the plurality of electrodes are made of metallic carbon nanotubes.

The protection layer 118 is made of a transparent and flexible material such as polycarbonate (PC), polymethyl methacrylate acrylic (PMMA), polyimide (PI), polyethylene terephthalate (PET), polyethylene (PE), polyether polysulfones (PES), polyvinyl polychloride (PVC), benzocyclobutenes (BCB), polyesters, or acrylic resin. The size and shape of the protection layer 118 can be selected according to need. In one embodiment, the thickness of the protection layer 118 is in a range from about 100 micrometers to about 500 micrometers. In one embodiment, the protection layer 118 is a flat PET plate with a thickness of 150 micrometers. The protection layer 118 is located the surface of the first transparent conductive layer 112 adjacent to the user.

The touch module 110 is flexible because all the first transparent conductive layer 112, the protection layer 118 and the plurality of electrodes are flexible.

The display module 120 can be can any type display having a second transparent conductive layer 122, such as a liquid crystal display (LCD), a field emission display (FED), electroluminescent display (ELD), vacuum fluorescent display (VFD), organic light emitting diode (OLED) display, cathode ray tube (CRT) display, electronic ink (E-ink) display, or electronic paper display (EPD). The surface of the display module 120 can be a flat or curved surface. The display module 120 can play other function at the same time. In one embodiment, the display module 120 is a liquid crystal display.

In one embodiment, the display module 120 is an electronic paper display. The electronic paper display can be micro-capsule type electrophoretic display, micro cup type electrophoretic display, gyricon bead type electrophoretic display, or partition type electrophoretic display.

The electronic paper display includes a low electrode plate, an electrophoretic medium layer, and an upper electrode plate stacked in that order. The electrophoretic medium layer is sandwiched between the low electrode plate and the upper electrode plate. The upper electrode plate includes an upper plate and the second transparent conductive layer 122 located on a surface of the upper plate adjacent to the electrophoretic medium layer. The low electrode plate includes a low plate and a plurality of pixel electrodes located on a surface of the low plate adjacent to the electrophoretic medium layer. The electrophoretic medium layer is in direct contact with the second transparent conductive layer 122 and the plurality of pixel electrodes. The surface of the upper plate away from the electrophoretic medium layer is used as a display surface adjacent to user.

The can be made of transparent flexible materials or transparent rigid materials such as glass, quartz, diamond, plastic or any other suitable material. The second transparent conductive layer 122 is transparent with a light transmittance greater than 70%, especially greater than 90%. The low electrode plate further includes a plurality of thin film transistors electrically connected to and used to control the plurality of pixel electrodes. The electrophoretic medium layer includes bistable electronic ink medium. In one embodiment, the electrophoretic medium layer includes a plurality of micro-capsules. Each micro-capsule packages a plurality of first electrophoresis ion and a plurality of second electrophoresis ion.

The low plate and the upper plate are optional. For example, the electronic paper display module 120 and the touch module 110 can use a common plate.

The second transparent conductive layer 122 is a component of the display module 120 and directly integrated in the display module 120. That is, the second transparent conductive layer 122 is an inherent transparent conductive layer of the display module 120. The material of the second transparent conductive layer 122 can be selected according to need, such as ITO, carbon nanotubes. The thickness of the second transparent conductive layer 122 can be in a range from about 50 micrometers to about 300 micrometers. The second transparent conductive layer 122 can be a patterned or an un-patterned. In one embodiment, the second transparent conductive layer 122 is a continuous un-patterned ITO film with a thickness in a range from about 50 micrometers to about 300 micrometers, such as 125 micrometers. Furthermore, the other necessary component of the display module 120 is not described in the disclosure and can be selected according to need.

Furthermore, an insulative support 130 is located between the touch module 110 and the display module 120 to insulate the touch module 110 and the display module 120 from each other.

As shown in FIG. 1, the insulative support 130 can be two strip shaped insulative elements or an insulative frame located on the periphery of two opposite surfaces of the touch module 110 and the display module 120. Thus, a space (not labeled) is defined by the insulative support 130, the touch module 110 and the display module 120. The strip shaped insulative elements or the insulative frame can be made of elastic material or rigid material such as glass, quartz, diamond, plastic. In one embodiment, the insulative support 130 is an insulative frame made of elastic material with a Young's modulus smaller than the Young's modulus of the OCA layer.

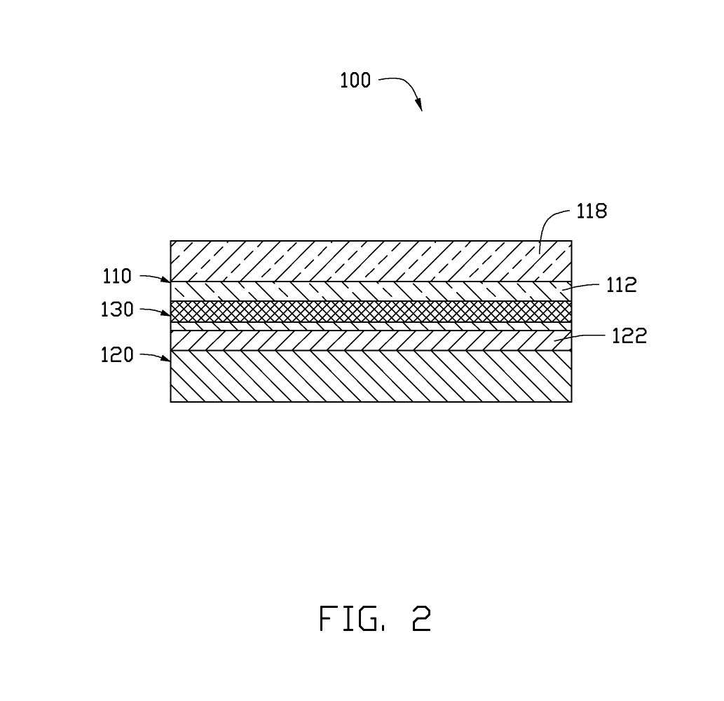

As shown in FIG. 2, the insulative support 130 can be a continuous insulative layer made of elastic material with a Young's modulus smaller than the Young's modulus of the OCA layer. The continuous insulative layer is in direct contact with the two opposite surfaces of the touch module 110 and the display module 120. The shape and size of the continuous insulative layer is the same as the shape and size of the two opposite surfaces of the touch module 110 and the display module 120.

The first transparent conductive layer 112 and the second transparent conductive layer 122 function as a touch pressure sensing unit together. Because the insulative support 130 is located between first transparent conductive layer 112 and the second transparent conductive layer 122, the distance between the first transparent conductive layer 112 and the second transparent conductive layer 122 is changeable under a pressure. When a touch is applied on the touch module 110 by a finger, the touch module 110 will detect the capacitance change of the first transparent conductive layer 112 and determine the position of the touch. When a pressure is applied on the touch module 110 by the finger, the distance between the first transparent conductive layer 112 and the second transparent conductive layer 122 will be changed. Thus, the capacitance between the first transparent conductive layer 112 and the second transparent conductive layer 122 will be changed. The pressure can be determined according to the capacitance change between the first transparent conductive layer 112 and the second transparent conductive layer 122. The apparatus having the touch sensitive device 100 will perform a function according to the pressure.

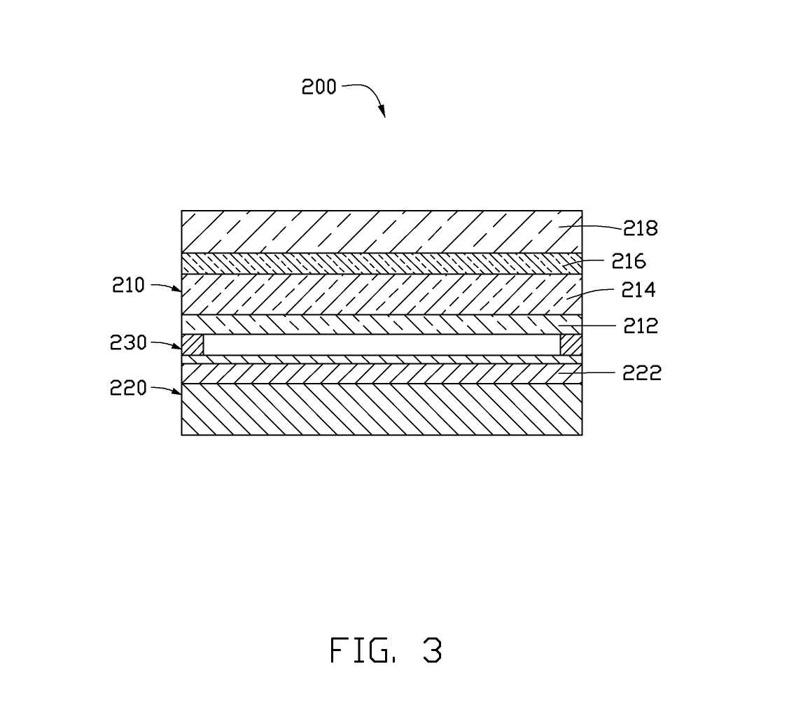

Referring to FIG. 3, a touch sensitive device 200 of one embodiment includes a touch module 210, and display module 220. The touch module 210 and the display module 220 are stacked with and spaced from each other.

The touch sensitive device 200 is similar to the touch sensitive device 100 above except that the touch module 210 is a mutual inductance capacitance-type touch module. The touch module 210 includes a first transparent conductive layer 212, a common substrate 214, a third transparent conductive layer 216, a protection layer 218, a plurality of first electrodes (not shown), and a plurality of second electrodes. The first transparent conductive layer 212, the common substrate 214, the third transparent conductive layer 216, and the protection layer 218 are stacked with each other in that order. The first transparent conductive layer 212 and the third transparent conductive layer 216 are located on two opposite surfaces of the common substrate 214. The protection layer 218 covers the third transparent conductive layer 216 and can be bonded to the third transparent conductive layer 216 by an OCA layer. The plurality of first electrodes are located on at least one side of and electrically connected with the first transparent conductive layer 212. The plurality of second electrodes are located on at least one side of and electrically connected with the third transparent conductive layer 216.

The first transparent conductive layer 212 is the same as the first transparent conductive layer 112 above. In one embodiment, the first transparent conductive layer 212 is a single carbon nanotube film.

The common substrate 214 is made of a transparent and flexible material such as polycarbonate (PC), polymethyl methacrylate acrylic (PMMA), polyimide (PI), polyethylene terephthalate (PET), polyethylene (PE), polyether polysulfones (PES), polyvinyl polychloride (PVC), benzocyclobutenes (BCB), polyesters, or acrylic resin. The thickness, size and shape of the common substrate 214 can be selected according to need. In one embodiment, the common substrate 214 is a flat PET plate with a thickness of 2 millimeters. The size and shape of the common substrate 214 is substantially the same as the size and shape of the first transparent conductive layer 212 and the third transparent conductive layer 216.

The third transparent conductive layer 216 can be a transparent conductive film with resistance anisotropy, such as a patterned TCO film, graphene film, carbon nanotube film, or metal mesh. In one embodiment, the third transparent conductive layer 216 a patterned ITO film with a thickness in a range from about 50 micrometers to about 300 micrometers, such as 125 micrometers.

The protection layer 218 and the display module 220 can be the same as the protection layer 118 and the display module 120 above. Furthermore, an insulative support 230 is located between the touch module 210 and the display module 220 to insulate the touch module 210 and the display module 220 from each other. The insulative support 230 is the same as the insulative support 130 above. The working principle of the touch sensitive device 200 is the same as the touch sensitive device 100 above.

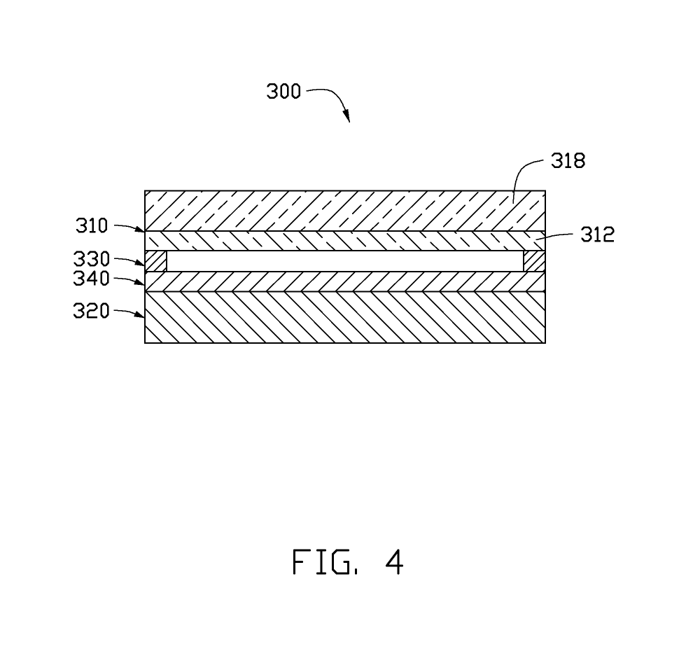

Referring to FIG. 4, a touch sensitive device 300 of one embodiment includes a touch module 310, display module 320, and a fourth transparent conductive layer 340. The touch module 310, the fourth transparent conductive layer 340 and the display module 320 are stacked with each other. In one embodiment, the touch module 310, the fourth transparent conductive layer 340 and the display module 320 are overlapped with each other. The fourth transparent conductive layer 340 is located between the touch module 310 and the display module 320. The fourth transparent conductive layer 340 is located on and in direct contact with a surface of the display module 320 and spaced from the touch module 310.

The touch sensitive device 300 is similar to the touch sensitive device 100 above except that a fourth transparent conductive layer 340 is located between the touch module 310 and the display module 320 and spaced from the touch module 310.

The touch module 310 includes a first transparent conductive layer 312, a plurality of electrodes (not shown) located on at least one side of and electrically connected with the first transparent conductive layer 312, a protection layer 318 covering the first transparent conductive layer 312. In one embodiment, the touch module 310 is a super-thin touch panel. The first transparent conductive layer 312 and the fourth transparent conductive layer 340 function as a touch pressure sensing unit together. The display module 320 is the same as the display module 120 above.

The fourth transparent conductive layer 340 can be a TCO film, graphene film, carbon nanotube film, or metal mesh. The fourth transparent conductive layer 340 can be patterned or un-patterned. In one embodiment, the fourth transparent conductive layer 340 is a continuous un-patterned ITO film with a thickness in a range from about 50 micrometers to about 300 micrometers, such as 125 micrometers. In one embodiment, the fourth transparent conductive layer 340 is a patterned carbon nanotube film having carbon nanotubes extending along a direction perpendicular with the extending direction of the carbon nanotubes of the first transparent conductive layer 312.

Furthermore, an insulative support 330 is located between the first transparent conductive layer 312 and the fourth transparent conductive layer 340 to insulate the first transparent conductive layer 312 and the fourth transparent conductive layer 340 from each other. The insulative support 330 is in direct contact with the first transparent conductive layer 312 and the fourth transparent conductive layer 340. Thus, the first transparent conductive layer 312 and the fourth transparent conductive layer 340 are only insulated by the insulative support 330. The insulative support 330 is the same as the insulative support 130 above.

When a touch pressure is applied on the touch module 310 by the finger, the distance between the first transparent conductive layer 312 and the fourth transparent conductive layer 340 will be changed, and the capacitance between the first transparent conductive layer 312 and the fourth transparent conductive layer 340 will be changed. The pressure can be determined according to the capacitance change between the first transparent conductive layer 312 and the fourth transparent conductive layer 340.

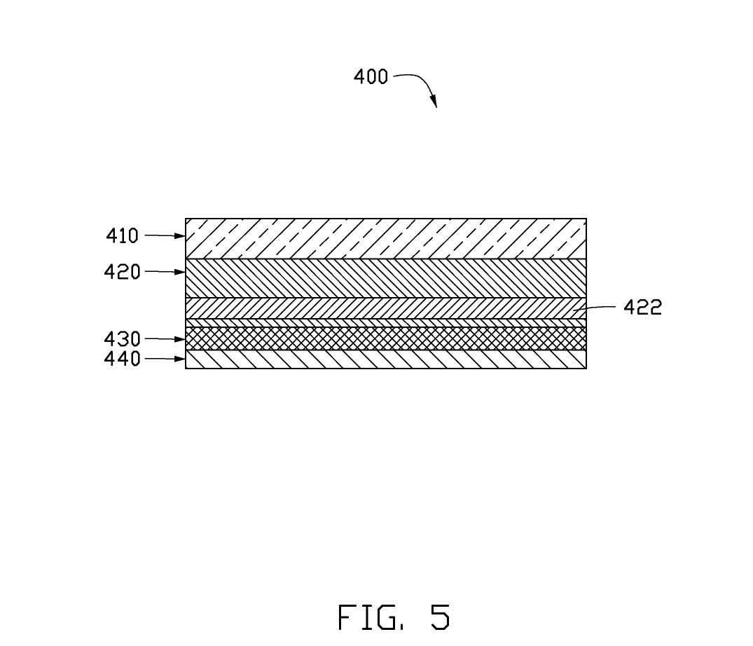

Referring to FIG. 5, a touch sensitive device 400 of one embodiment includes a touch module 410, display module 420, and a fifth conductive layer 440. The touch module 410, the display module 420, and the fifth conductive layer 440 are stacked with each other. In one embodiment, the touch module 410, the display module 420, and the fifth conductive layer 440 are overlapped with each other. The display module 420 is located between the touch module 410 and the fifth conductive layer 440.

The touch sensitive device 400 is similar to the touch sensitive devices 100, 200 above except that a fifth conductive layer 440 is located on the surface of the display module 420 away from the touch module 410. The fifth conductive layer 440 can be a transparent conductive layer described above or an opaque conductive layer such as a metal film, conductive ceramic film, a conductive polymer film, or a conductive silver paste layer. The fifth conductive layer 440 can be a patterned or an un-patterned. In one embodiment, the fifth conductive layer 440 is a continuous un-patterned aluminum film with a thickness in a range from about 50 micrometers to about 300 micrometers, such as 125 micrometers.

The display module 420 includes a second transparent conductive layer 422. The second transparent conductive layer 422 is the same as the second transparent conductive layer 122 above. The second transparent conductive layer 422 is a component of the display module 420 and directly integrated in the display module 420. The second transparent conductive layer 422 is adjacent to the fifth conductive layer 440.

The touch module 410 can be a self inductance capacitance-type touch module, a mutual inductance capacitance-type touch module or other type of touch module. The display module 420 is the same as the display module 120 above. In one embodiment, the display module 420 is an electronic paper display, and the plurality of pixel electrodes are used as the second transparent conductive layer 422. The plurality of pixel electrodes are inherent transparent conductive layer of the display module 420 and integrated in the display module 420.

Furthermore, an insulative support 430 is located between the fifth conductive layer 440 and the display module 420 to insulate the fifth conductive layer 440 and the second transparent conductive layer 422 from each other. The insulative support 430 is the same as the insulative support 130 above. When the insulative support 430 is two strip shaped insulative elements or an insulative frame, the insulative support 430 is located on the periphery of the display module 420. The fifth conductive layer 440 should be a free-standing structure, such as a metal plate, or formed on a surface of a free-standing plate such as a glass plate. A space (not labeled) is defined by the insulative support 430, the fifth conductive layer 440 and the display module 420. In one embodiment, the insulative support 430 is a continuous insulative layer made of elastic material with a Young's modulus smaller than the Young's modulus of the OCA layer, and the fifth conductive layer 440 is located on and in direct contact with the surface of the insulative support 430 away from the display module 420. In one embodiment, the display module 420 is an electronic paper display, and the low plated of the display module 420 is used as the insulative support 430.

The fifth conductive layer 440 and the second transparent conductive layer 422 function as a touch pressure sensing unit together. The working principle of the touch pressure sensing unit of touch sensitive device 400 is the same as the working principle of the touch pressure sensing unit of the touch sensitive device 100.

The touch module 410 and the display module 420 can be in direct contact with or spaced from each other. In one embodiment, the touch module 410 and the display module 420 are bonded together and insulated from each other by a rigid insulative layer therebetween.

Furthermore, the touch module 410 can be omitted if the touch position is not needed to be determined. The touch sensitive device 400 consists of the display module 420, the insulative support 430, and the fifth conductive layer 440.

It is to be understood that the above-described embodiments are intended to illustrate rather than limit the disclosure. Any elements described in accordance with any embodiments is understood that they can be used in addition or substituted in other embodiments. Embodiments can also be used together. Variations may be made to the embodiments without departing from the spirit of the disclosure. The above-described embodiments illustrate the scope of the disclosure but do not restrict the scope of the disclosure.

Depending on the embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

What is claimed is:

1. A touch sensitive device comprising:
a touch module comprising a first transparent conductive layer; and
a display module comprising a second transparent conductive layer, and the touch module and the display module being stacked with and spaced from each other,
wherein a distance between the first transparent conductive layer and the second transparent conductive layer is changeable, and the first transparent conductive layer and the second transparent conductive layer function together as a touch pressure sensing unit.

2. The touch sensitive device of claim 1, further comprising an insulative support located between the touch module and the display module to insulate the touch module and the display module from each other.

3. The touch sensitive device of claim 2, wherein the insulative support comprises two strip shaped insulative elements located on periphery of two opposite surfaces of the touch module and the display module.

4. The touch sensitive device of claim 3, wherein the insulative support is an insulative frame.

5. The touch sensitive device of claim 3, wherein a space is defined by the insulative support, the touch module and the display module.

6. The touch sensitive device of claim 3, wherein the insulative support comprises a rigid material selected from the group consisting of glass, quartz, diamond, and plastic.

7. The touch sensitive device of claim 2, wherein the insulative support is a continuous insulative layer.

8. The touch sensitive device of claim 7, wherein the insulative support comprises an elastic material with a Young's modulus smaller than a Young's modulus of an optically clear adhesive layer.

9. The touch sensitive device of claim 1, wherein the display module is selected from the group consisting of a liquid crystal display, a field emission display, an electroluminescent display, a vacuum fluorescent display, an organic light emitting diode display, a cathode ray tube display, an electronic ink display, and an electronic paper display.

10. The touch sensitive device of claim 1, wherein the second transparent conductive layer is an inherent transparent conductive layer of the display module.

11. The touch sensitive device of claim 1, wherein the second transparent conductive layer is a patterned transparent conductive layer.

12. The touch sensitive device of claim 1, wherein the second transparent conductive layer is an un-patterned transparent conductive layer.

13. The touch sensitive device of claim 1, wherein the display module is an electronic paper display comprising a first electrode plate, an electrophoretic medium layer, and a second electrode plate stacked in that order; and the first electrode plate comprises a first plate and the second transparent conductive layer located on a surface of the first plate adjacent to the electrophoretic medium layer.

14. The touch sensitive device of claim 1, wherein the touch module comprises the first transparent conductive layer, a plurality of electrodes located on at least one side of and electrically connected with the first transparent conductive layer, and a protection layer covering the first transparent conductive layer.

15. The touch sensitive device of claim 14, wherein the touch module is a super-thin touch panel consisting of the first transparent conductive layer, the protection layer, and the plurality of electrodes.

16. The touch sensitive device of claim 14, wherein the first transparent conductive layer is located on and bonded with a surface of the protection layer by an optically clear adhesive layer.

17. The touch sensitive device of claim 1, wherein the touch module further comprises:
a common substrate having two opposite surfaces;
a third transparent conductive layer, wherein the first transparent conductive layer and the third transparent conductive layer are located on the two opposite surfaces of the common substrate;
a plurality of first electrodes located on at least one side of and electrically connected with the first transparent conductive layer;
a plurality of second electrodes located on at least one side of and electrically connected with the third transparent conductive layer; and
a protection layer covering the third transparent conductive layer.

18. The touch sensitive device of claim 1, wherein the first transparent conductive layer is a carbon nanotube film with resistance anisotropy.

19. The touch sensitive device of claim 18, wherein the carbon nanotube film is a pure structure consisting of a plurality of carbon nanotubes joined end-to-end by van der Waals force therebetween.

20. A touch sensitive device comprising:
a touch module comprising a first transparent conductive layer;
a display module comprising a second transparent conductive layer, and the touch module and the display module being stacked with and spaced from each other; and
an insulative support located between the touch module and the display module,
wherein the insulative support is made of an elastic material with a Young's modulus smaller than a Young's modulus of an optically clear adhesive layer;
wherein a distance between the first transparent conductive layer and the second transparent conductive layer is changeable, and the first transparent conductive layer and the second transparent conductive layer function together as a touch pressure sensing unit.
